(19) United States
(12) Patent Application Publication
(10) Pub. No.: US 2025/0265408 A1
(43) Pub. Date: Aug. 21, 2025

(54) METHOD AND APPARATUS FOR GENERATING CONFLICT SENTENCE

(71) Applicants: NCSOFT Corporation, Seoul (KR); RESEARCH AND BUSINESS FOUNDATION SUNGKYUNKWAN UNIVERSITY, Suwon-si (KR)

(72) Inventors: Young June KIM, Seongnam-si (KR); Young Rok SONG, Seongnam-si (KR); Sae Byeok LEE, Seongnam-si (KR); Chung Hee LEE, Seongnam-si (KR); Yun Gyung CHEONG, Anyang-si (KR)

(73) Assignees: NCSOFT Corporation, Seoul (KR); RESEARCH & BUSINESS FOUNDATION SUNGKYUNKWAN UNIVERSITY, Suwon-si (KR)

(21) Appl. No.: 19/201,155

(22) Filed: May 7, 2025

Related U.S. Application Data
(63) Continuation of application No. PCT/KR2023/003851, filed on Mar. 23, 2023.

(51) Int. Cl. G06F 40/166; G06F 18/241; G06F 40/284; G06F 40/289; G06F 40/40

(52) U.S. Cl. CPC G06F 40/166; G06F 18/241; G06F 40/284; G06F 40/289; G06F 40/40

(57) ABSTRACT

Disclosed are a method and apparatus for dynamic story generation. The method includes generating, using a first inference model, a first output sentence based on a seed sentence, the first output sentence describing a goal of a subject of the seed sentence; and generating, using a second inference model, a second output sentence describing a conflict associated with the goal of the subject of the seed sentence, based on the seed sentence and the first output sentence.

### CROSS-REFERENCES TO RELATED APPLICATION

This application is a continuation of International Application No. PCT/KR2023/003851, filed on Mar. 23, 2023, with the Korean Intellectual Property Office, the discourse of which is incorporated by reference herein in its entirety.

### FIELD

The disclosed embodiments relate to generating stories through language processing models. For example, embodiments relate to generating a conflict sentence, and methods and apparatus for the same.

### BACKGROUND

A conflict, such as an external conflict and an internal conflict, is a key element that arouses the reader's interest and makes the reader want to read a story to the end. Recently, studies on automatically generating stories using computers have been steadily progressing, but these studies generally end up generating monotonous stories without conflict or challenges to rouse users' interest.

### SUMMARY

A method for dynamically generating a story, performed by a computing device including one or more processors, includes generating, using a first inference model, a first output sentence based on a seed sentence, the first output sentence describing a goal of a subject of the seed sentence; and generating, using a second inference model, a second output sentence describing a conflict associated with the goal of the subject of the seed sentence, based on the seed sentence and the first output sentence.

An apparatus for dynamically generating a story according to an embodiment includes one or more processors and memory storing one or more programs executed by the one or more processors. The one or more processors are configured to: generate, using a first inference model, a first output sentence based on a seed sentence, the first output sentence describing a goal of a subject of the seed sentence; and generate, using a second inference model, a second output sentence describing a conflict associated with the goal of the subject of the seed sentence, based on the seed sentence and the first output sentence.

### BRIEF DESCRIPTION OF THE DRAWINGS

FIG. 1 is a block diagram illustrating an apparatus for generating a story and/or a conflict sentence according to an embodiment.

FIG. 2 is a diagram illustrating an example of generating a first output sentence using a first inference model according to an embodiment.

FIG. 3 is a diagram illustrating an example of generating a second output sentence using a second inference model according to an embodiment.

FIG. 4 is a block diagram of an apparatus for generating a story and/or a conflict sentence according to an embodiment.

FIG. 5 is a diagram illustrating an example of generating a classification label using a classification model according to an embodiment.

FIG. 6 is a flowchart illustrating a method of generating a story and/or a conflict sentence according to an embodiment.

FIG. 7 is a flowchart of a method for generating a story and/or a conflict sentence according to an additional embodiment.

FIG. 8 is a block diagram for illustratively describing an example of a computing environment including a computing device according to an embodiment.

### DETAILED DISCLOSURE

Hereinafter, a specific embodiment will be described reference to the accompanying drawings. The detailed description below is provided to aid in a comprehensive understanding of the methods, apparatuses, and/or systems described in this specification. However, this is only an example and the present invention is not limited thereto.

In describing the embodiments, if it is determined that a specific description of a related known technology may unnecessarily obscure the gist of the present invention, the detailed description thereof will be omitted. In addition, the terms described below are terms defined in consideration of the functions, and may vary depending on the intention or custom of the user or operator. Therefore, the definition thereof should be made based on the contents throughout this specification. The terms used in the detailed description are for the purpose of describing embodiments only and should not be taken to be limiting. Unless clearly used otherwise, singular forms include plural forms. In this description, expressions such as “including” or “having” are intended to indicate certain features, numbers, steps, operations, elements, portions, or combinations thereof, and should not be construed to exclude the presence or possibility of one or more other features, numbers, steps, operations, elements, portions, or combinations thereof other than those described.

According to the disclosed embodiments, by generating a goal sentence that infers a goal of a subject of a seed sentence based on the seed sentence, and generating a sentence including a conflict element or challenges to meet the goal based on a seed sentence and a goal sentence, it is possible to go beyond creating a monotonous story without conflict and create a story including a conflict that arouses the reader's interest. It should be understood that the generation of sentence is used as an example. This disclosure is not limited thereto.

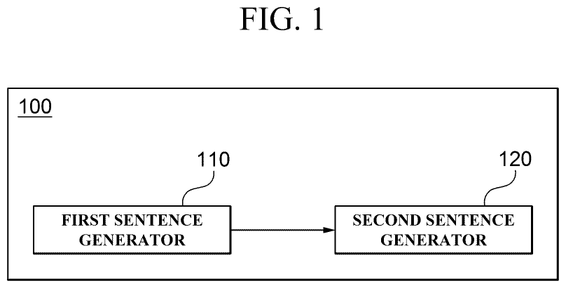

FIG. 1 is a diagram illustrating a configuration of an apparatus for generating a conflict sentence according to an embodiment.

Referring to FIG. 1, an apparatus 100 for generating a conflict sentence includes a first sentence generator 110 and a second sentence generator 120.

According to an embodiment, the first sentence generator 110 and the second sentence generator 120 may be implemented by using one or more physically separated devices, may be implemented by one or more hardware processors or a combination of one or more hardware processors and software, and may not be clearly distinguished in a specific operation, unlike the illustrated example.

The first sentence generator 110 uses a first inference model to generate a first output sentence describing a goal of a subject of a seed sentence based on the seed sentence.

According to an embodiment, the seed sentence may be a sentence that includes a subject and describes a state, a situation, an emotion, a thought, an action, etc. of the subject. In addition, the goal of the subject of the seed sentence may refer to a state, a situation, an emotion, a thought, or an action of the subject that may occur due to a state, a situation, an emotion, a thought, or an action of the subject described in the seed sentence as a premise or cause.

According to an embodiment, the first inference model may be an artificial neural network-based language model trained to infer the goal of the subject of the seed sentence based on the seed sentence. Specifically, according to an embodiment, the first inference model may be trained to perform common sense-based inference on the goal of the subject of the seed sentence input to the first inference model using a pre-built knowledge base as training data. Specifically, the first inference model may be, for example, a model obtained by performing fine-tuning on a pre-trained transformer-based language model, such as Bidirectional Auto-Regressive Transformer (BART), Text-to-Text Transfer Transformer (T5), GPT-2, GPT-2 XL, GPT-3, Bidirectional Encoder Representations from Transformers (BERT), Robustly optimized BERT approach (ROBERTa), A Lite BERT (ALBERT), etc., using the pre-built knowledge base.

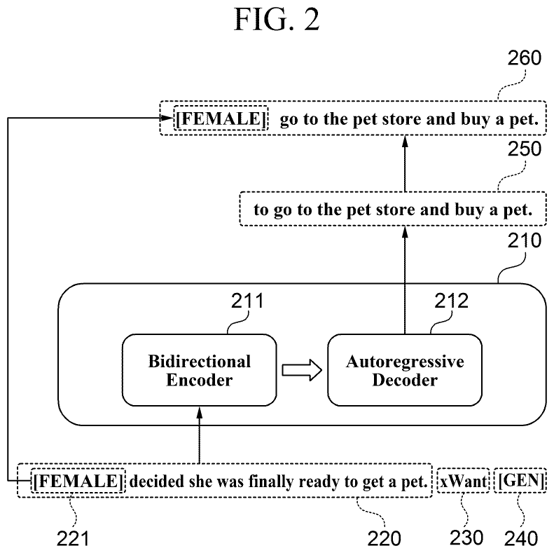

FIG. 2 is a diagram illustrating an example of generating a first output sentence using a first inference model according to an embodiment.

In the example shown in FIG. 2, a first inference model 210 is assumed to be a model obtained by performing fine-tuning on a pre-trained BART model, which included a bidirectional encoder 211 and an autoregressive decoder 212 based on a transformer model, by using a knowledge base. However, the first inference model 210 is sufficient to be a trained model that can generate a sentence that infers the goal of the subject of the seed sentence based on the seed sentence, and an artificial neural network structure and training method of the first inference model 210 are not limited to a specific embodiment.

Referring to FIG. 2, the bidirectional encoder 211 may receive a seed sentence 220, a relationship token 230, and a special token 240 and generate a multi-dimensional vector corresponding to the seed sentence 220. In this case, ‘[GEN]’, which is the special token 240, indicates that the first inference model 210 should generate a sentence that follows ‘[GEN]’, and ‘xWant’, which is the relationship token 230, indicates that a sentence to be generated by the first inference model 210 should be an inference of a goal of a subject 221 of the seed sentence 220.

The autoregressive decoder 212 may receive the multi-dimensional vector generated by the bidirectional encoder 211 and generate a sentence 250 that infers a goal of a subject 221 of the seed sentence 220 in an autoregressive manner.

Meanwhile, the first sentence generator 120 may generate a first output sentence 260 by replacing “to”, which is the first word of the sentence 250 generated by the autoregressive decoder 212, with the subject 221 of the seed sentence 220.

Meanwhile, an input format of the first inference model 210 is not necessarily limited to the example illustrated in FIG. 2, and may be variously changed according to a type of the first inference model 210, a training method for the first inference model 210, etc.

Referring back to FIG. 1, the second sentence generator 120 uses a second inference model to generate a second output sentence describing a conflict element for the first output sentence based on the seed sentence and the first output sentence.

According to an embodiment, the conflict element for the first output sentence may mean an element for weakening the likelihood that the subject of the seed sentence will reach the goal described in the first output sentence. For example, the conflict element for the first output sentence may be a state, an emotion, a thought, an action, or a surrounding situation of a subject that prevents the possibility that a state, an emotion, a thought, or an action of the subject described in the seed sentence will lead to a state, an emotion, a thought, or an action of the subject described in the first output sentence. As another example, the conflict element may include description of challenges to the goal of the subject.

According to an embodiment, the second inference model may be an artificial neural network-based language model trained to generate a conflict sentence for the goal sentence based on the seed sentence and a goal sentence for the seed sentence. In this case, the goal sentence for the seed sentence may mean a sentence describing the goal of the subject of the seed sentence, and the conflict sentence for the goal sentence may mean a sentence describing the conflict element for the goal sentence.

According to an embodiment, the second inference model may be trained to infer a conflict sentence for a hypothesis sentence from a premise sentence and the hypothesis sentence by using first training data including the premise sentence, the hypothesis sentence pre-classified as a goal sentence describing a goal of a subject of the premise sentence and a conflict sentence pre-classified as describing the conflict element for the hypothesis sentence. Specifically, the second inference model may be, for example, a model obtained by performing fine-tuning on the pre-trained transformer-based language model, such as the BART, T5, GPT-2, GPT-2 XL, GPT-3, BERT, ROBERTa, ALBERT, etc. using first training data.

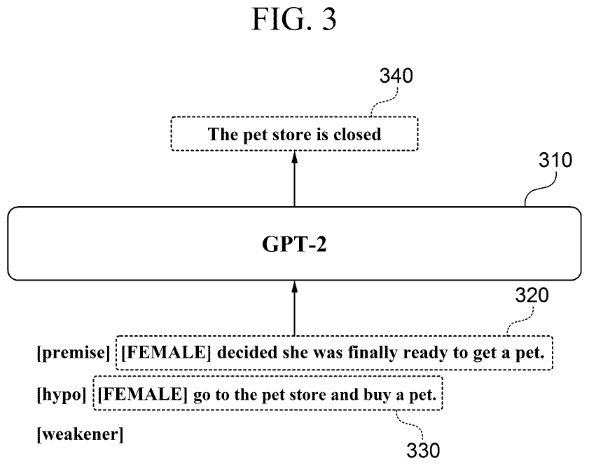

FIG. 3 is a diagram illustrating an example of generating a second output sentence using the second inference model according to an embodiment.

In the example shown in FIG. 3, a second inference model 310 is assumed to be one obtained by performing fine-tuning on a pre-trained GPT-2 model using the first training data. However, the second inference model 310 is sufficient to be a trained model that can generate the conflict sentence for the goal sentence from the seed sentence and the goal sentence for the seed sentence, and an artificial neural network structure and training method of the second inference model 310 are not limited to a specific embodiment.

Referring to FIG. 3, the second inference model 310 may receive a seed sentence 320 and a first output sentence 330 generated based on the seed sentence 320 as a premise sentence and a hypothesis sentence, respectively, and generate a second output sentence 340 that describes a conflict element for the first output sentence 330.

Meanwhile, the input of the second inference model 310 may further include special tokens “[precise]”, “[hypo]”, and “[weakener]”, in addition to the seed sentence 320 and the first output sentence 330. The “[premise]” and “[hypo]” are tokens for distinguishing between a premise sentence and a hypothesis sentence, and the “[weakener]” is a token indicating that the second inference model 310 should infer a conflict sentence.

Meanwhile, an input format of the second inference model 310 is not necessarily limited to the example illustrated in FIG. 3, and may be variously changed according to a type of the second inference model 310 or a training method for the second inference model 310.

While sentences are used as an example, it will be understood that this disclosure is not limited thereto.

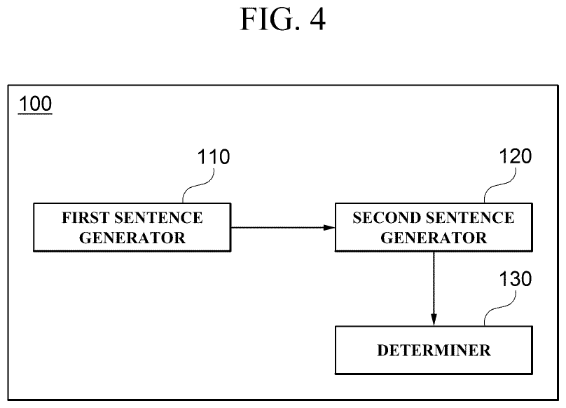

FIG. 4 is a configuration diagram of an apparatus for generating a conflict sentence according to an additional embodiment.

Referring to FIG. 4, the apparatus 100 for generating the conflict sentence may further include a determiner 130.

According to an embodiment, the first sentence generator 110, the second sentence generator 120, and the determiner 130 may be implemented by using one or more physically separated devices, may be implemented by one or more hardware processors or a combination of one or more hardware processors and software, and may not be clearly distinguished in a specific operation, unlike the illustrated example.

The determiner 130 may use the classification model to determine whether the second output sentence generated by the second sentence generator 120 describes the conflict element for the first output sentence.

According to an embodiment, the classification model may output a preset classification label indicating whether the second output sentence describes a conflict element for the first output sentence based on the seed sentence, the first output sentence, and the second output sentence, and the determiner 130 may determine whether the second output sentence describes the conflict element for the first output sentence based on the classification label output by the classification model.

According to an embodiment, the classification model may be an artificial neural network-based model trained by using second training data including a premise sentence, a hypothesis sentence pre-classified as a goal sentence describing a goal of a subject of the premise sentence and a non-conflict sentence pre-classified as describing a non-conflict element for the hypothesis sentence. The non-conflict element may include description of events or challenges that were overcome or description of solutions to conflicts.

In this case, according to an embodiment, the non-conflict element for the hypothesis sentence may mean an element that strengthens the likelihood that a subject of the premise sentence will reach a goal described in the hypothesis sentence. For example, the non-conflict element for the hypothesis sentence may be a state, an emotion, a thought, an action, or a surrounding situation of a subject that strengthens the possibility that a state, an emotion, a thought, or an action of the subject described in the premise sentence will lead to a state, an emotion, a thought, or an action of the subject described in the hypothesis sentence.

According to an embodiment, the classification model may be a binary classification model trained to output a first label corresponding to a conflict sentence from the premise sentence, the hypothesis sentence and the conflict sentence included in the second training data, and output a second label corresponding to the non-conflict sentence from the premise sentence, the hypothesis sentence, and the non-conflict sentence included in the second training data. Specifically, the classification model may be, for example, a model obtained by performing fine-tuning on a pre-trained transformer-based language model, such as the BART, T5, GPT-2, GPT-2 XL, GPT-3, BERT, ROBERTa, ALBERT, etc. using second training data.

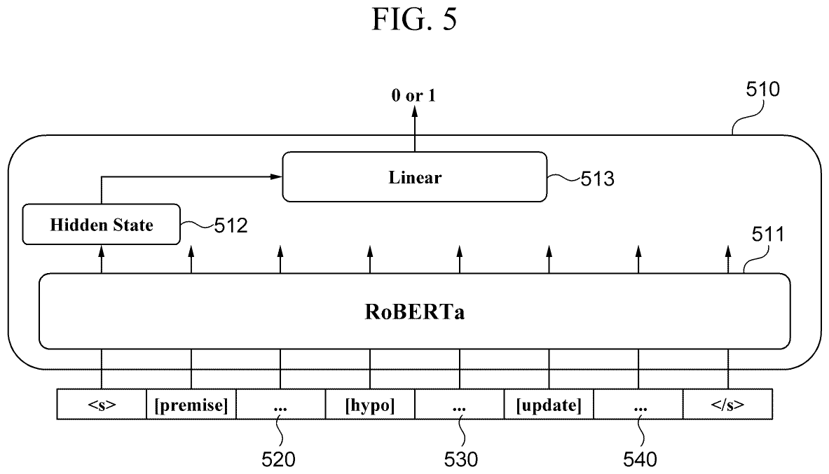

FIG. 5 is a diagram illustrating an example of generating a classification label using a classification model according to an embodiment.

In the example shown in FIG. 5, a classification model 510 is assumed to be a model obtained by performing fine-tuning on a pre-trained ROBERTa model-based language model using the second training data. However, the classification model 510 is sufficient to be a model that can generate a label indicating whether a query sentence includes a conflict element for a goal sentence from a seed sentence, the goal sentence for the seed sentence, and the query sentence using the second training data, and an artificial neural network structure and training method of the the classification model 510 are not limited to a specific embodiment.

Referring to FIG. 5, the classification model 510 may include a ROBERTa model 511 and a linear layer 513. The classification model 510 may receive a seed sentence 520, a first output sentence 530, and a second output sentence 540 as a premise sentence, a hypothesis sentence, and a query sentence, respectively, and may receive special tokens including “<s>”, “[premise]”, “[hypo]”, “[update]”, and “</s>” together with the corresponding sentences. In this case, the “[premise]”, “[hypo]”, and “[update]” are tokens that distinguish between the premise sentence, the hypothesis sentence, and the query sentence, respectively, and the “<s>” and “</s>” are tokens that indicate the start and end of the input.

Meanwhile, the linear layer 513 may receive a vector representing a hidden state 512 for the “<s>” token among hidden states of the last hidden layer of the ROBERTa model 511 and output “0” or “1” as a classification label for the query sentence 540. In this case, “0” may be a classification label indicating that the query sentence 540 does not include a conflict element, and “1” may be a classification label indicating that the query sentence 540 includes the conflict element. However, the type of the classification label is not necessarily limited to the example illustrated in FIG. 5, and may be variously set according to embodiments.

Meanwhile, the input format of the classification model 510 is not necessarily limited to the example illustrated in FIG. 5, and may be variously changed according to a type of the classification model 510 or a training method for the classification model 510.

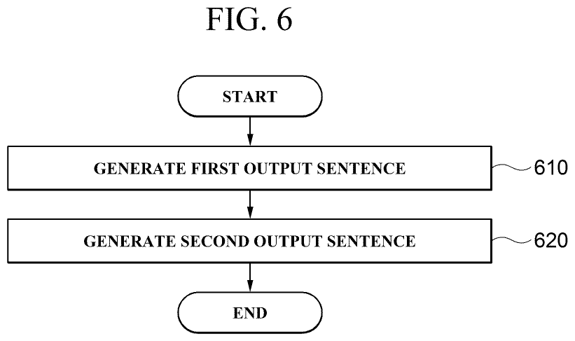

FIG. 6 is a flowchart illustrating a method of generating a conflict sentence according to an embodiment.

The method illustrated in FIG. 6 may be performed by, for example, the apparatus 100 for generating the conflict sentence illustrated in FIG. 1 or 4.

Referring to FIG. 6, the apparatus 100 for generating the conflict sentence generates a first output sentence describing a goal of a subject of a seed sentence based on the seed sentence, by using a first inference model (610).

Thereafter, the apparatus 100 for generating the conflict sentence generates a second output sentence describing a conflict element for the first output sentence based on the seed sentence and the first output sentence, by using a second inference model (620).

Meanwhile, in the flowchart illustrated in FIG. 6, at least some of the steps may be performed together by being combined with other steps, may be performed by being divided into sub-steps, or may be performed by being added with one or more steps (not illustrated).

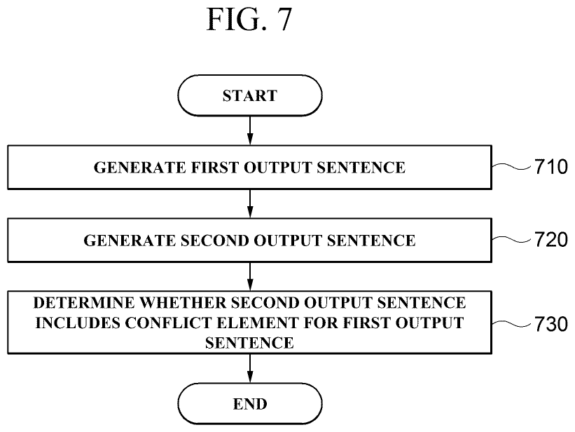

FIG. 7 is a flowchart of a method of generating a conflict sentence according to an additional embodiment.

The method illustrated in FIG. 7 may be performed by, for example, the apparatus 100 for generating the conflict sentence illustrated in FIG. 4.

Referring to FIG. 7, the apparatus 100 for generating the conflict sentence generates a first output sentence describing a goal of a subject of a seed sentence based on the seed sentence, by using a first inference model (710).

Thereafter, the apparatus 100 for generating the conflict sentence generates a second output sentence describing a conflict element for the first output sentence based on the seed sentence and the first output sentence, by using a second inference model (720).

Thereafter, the apparatus 100 for generating the conflict sentence determine whether the second output sentence includes a conflict element for the first output sentence, by using a classification model (730).

Meanwhile, in the flowchart illustrated in FIG. 7, at least some of the steps may be performed together by being combined with other steps, may be performed by being divided into sub-steps, or may be performed by being added with one or more steps (not illustrated).

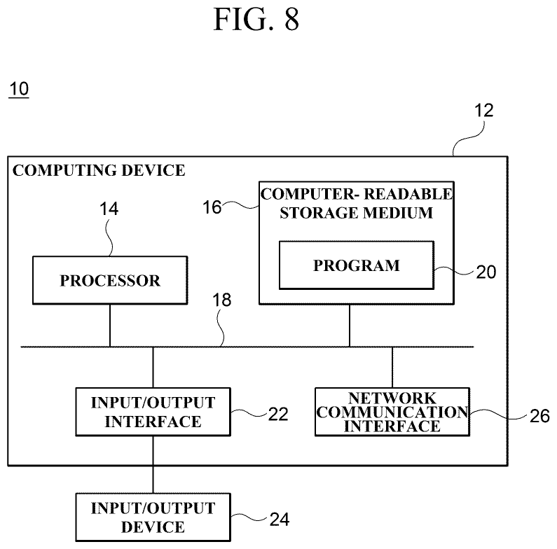

FIG. 8 is a block diagram for illustratively describing a computing environment including a computing device according to an embodiment.

In the embodiment illustrated in FIG. 8, respective components may have different functions and capabilities other than those described below, and may include additional components in addition to those described below.

An illustrated computing environment 10 includes a computing device 12. The computing device 12 may be one or more components included in the apparatus 100 for generating the conflict sentence according to an embodiment.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer- executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non- volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

Although the present invention has been described in detail through representative examples above, those skilled in the art will understand that various modifications may be made to the above-described embodiments without departing from the scope of the present invention. Therefore, the scope of the rights of the present invention should not be limited to the described embodiments, but should be determined by the claims described below as well as equivalents of the claims.

What is claimed is:

1. A method of dynamic story generation, the method being executed by one or more processors, the method comprising:
generating, using a first inference model, a first output sentence based on a seed sentence, the first output sentence describing a goal of a subject of the seed sentence; and
generating, using a second inference model, a second output sentence describing a conflict associated with the goal of the subject of the seed sentence, based on the seed sentence and the first output sentence.

2. The method of claim 1, wherein the first inference model is a first neural network-based model trained to perform common sense-based inference using a pre-built knowledge base as training data.

3. The method of claim 2, wherein the first inference model is based on fine-tuning a first pre-trained transformer-based language model using the pre-built knowledge base.

4. The method of claim 1, wherein the second inference model is a second neural network-based model trained using first training data, the first training data comprising a premise sentence, a hypothesis sentence that is pre-classified as a goal sentence describing a goal of a subject of the premise sentence, and a conflict sentence that is pre-classified as describing a conflict for the hypothesis sentence, the conflict for the hypothesis sentence being associated with challenges to the goal of the subject of the premise sentence.

5. The method of claim 4, wherein the second inference model is based on fine-tuning a second pre-trained transformer-based language model by using the first training data.

6. The method of claim 1, further comprising:
determining whether the second output sentence describes the conflict associated with challenges to the goal of the subject of the seed sentence based on the seed sentence, the first output sentence, and the second output sentence using a classification model.

7. The method of claim 6, wherein the classification model is a third neural network-based model trained using second training data, the second training data comprising a premise sentence, a hypothesis sentence that is pre-classified as a goal sentence describing a goal of a subject of the premise sentence, a conflict sentence that is pre-classified as describing a conflict for the hypothesis sentence, the conflict for the hypothesis sentence being associated with challenges to the goal of the subject of the premise sentence, and a non-conflict sentence that is pre-classified as describing a non-conflict for the hypothesis sentence, the non-conflict being associated with the goal of the subject of the premise sentence.

8. The method of claim 7, wherein the classification model is based on fine-tuning a third pre-trained transformer-based language model using the second training data.

9. The method of claim 6, wherein the determining comprises determining whether the second output sentence describes the conflict associated with the challenges to the goal of the subject of the seed sentence based on a preset classification label from the classification model.

10. An apparatus for dynamic story generation, the apparatus comprising:
one or more processors; and
memory storing one or more instructions that are executed by the one or more processors, wherein the one or more processors are configured to:
generate, using a first inference model, a first output sentence based on a seed sentence, the first output sentence describing a goal of a subject of the seed sentence; and
generate, using a second inference model, a second output sentence describing a conflict associated with the goal of the subject of the seed sentence, based on the seed sentence and the first output sentence.

11. The apparatus of claim 10, wherein the first inference model is a first neural network-based model trained to perform common sense-based inference using a pre-built knowledge base as training data.

12. The apparatus of claim 11, wherein the first inference model is based on fine-tuning a first pre-trained transformer-based language model using the pre-built knowledge base.

13. The apparatus of claim 10, wherein the second inference model is a second neural network-based model trained using first training data, the first training data comprising a premise sentence, a hypothesis sentence that is pre-classified as a goal sentence describing a goal of a subject of the premise sentence and a conflict sentence that is pre-classified as describing a conflict for the hypothesis sentence, the conflict for the hypothesis sentence being associated with challenges to the goal of the subject of the premise sentence.

14. The apparatus of claim 13, wherein the second inference model is based on fine-tuning a second pre-trained transformer-based language model using the first training data.

15. The apparatus of claim 10, wherein the one or more processors are further configured to determine whether the second output sentence describes the conflict associated with challenges to the goal of the subject of the seed sentence based on the seed sentence, the first output sentence, and the second output sentence using a classification model.

16. The apparatus of claim 15, wherein the classification model is a third neural network-based model trained using second training data, the second training data comprising a premise sentence, a hypothesis sentence that is pre-classified as a goal sentence describing a goal of a subject of the premise sentence, a conflict sentence that is pre-classified as describing a conflict for the hypothesis sentence, the conflict for the hypothesis sentence being associated with challenges to the goal of the subject of the premise sentence, and a non-conflict sentence that is pre-classified as describing a non-conflict for the hypothesis sentence, the non-conflict being associated with the goal of the subject of the premise sentence.

17. The apparatus of claim 16, wherein the classification model is based on fine-tuning a third pre-trained transformer-based language model using the second training data.

18. The apparatus of claim 15, wherein the determining comprises determining whether the second output sentence describes the conflict associated with the challenges to the goal of the subject of the seed sentence based on a preset classification label from the classification model.

19. The method of claim 1, wherein the first output sentence is generated using the first inference model based on the seed sentence, a relationship token, and a first special token, the special token indicating a first task type for the first inference model; and
wherein the second output sentence is generated using the second inference model based on the seed sentence, the first output sentence, and a second special token, the second special token indicating a type of sentence to be generated by the second inference model.

20. The apparatus of claim 10, wherein the first output sentence is generated using the first inference model based on the seed sentence, a relationship token, and a first special token, the special token indicating a first task type for the first inference model; and
wherein the second output sentence is generated using the second inference model based on the seed sentence, the first output sentence, and a second special token, the second special token indicating a type of sentence to be generated by the second inference model.
